(19) United States
(12) Patent Application Publication
(10) Pub. No.: US 2021/0076125 A1
(43) Pub. Date: Mar. 11, 2021

(54) Conical Ear Pad

(71) Applicants: Anthony James Crocker, Tulsa, OK (US); Aaron Scott Crocker, Georgetown, OH (US)

(72) Inventors: Anthony James Crocker, Tulsa, OK (US); Aaron Scott Crocker, Georgetown, OH (US)

(21) Appl. No.: 17/067,085

(22) Filed: Oct. 9, 2020

(51) Int. Cl. H04R 1/10

(52) U.S. Cl. CPC H04R 1/1083; H04R 1/1008; H04R 1/1066

(57) ABSTRACT

A headphone ear pad couples the headphone cup, that holds the transducer, with the listener's ear. Ear pad patents typically focus on materials usage, comfort, or sound isolation. This patent focuses on the ear pad as sound delivery mechanism with the ability to alter the manner in which sound is perceived by the listener or other receptor. This is accomplished through the conical shape of the pad, multi-walled structure, incorporation of sound wave disrupters, and pressure ventilators.

### STATEMENT REGARDING FEDERALLY SPONSORED RESEARCH OR DEVELOPMENT

This invention was not made with government support.

### FIELD OF CLASSIFICATION

### USPC 129 Acoustics/Ear

### USPC 182 Acoustics/Resonant Chamber

USPC 183 Acoustics/Double wall

### USPC 186 Acoustics/Adjustable

### REFERENCES CITED

US Patents most closely related:

| | | |
|---|---|---|
| 1,527,802 | February 1925 | Huggins |
| 1,615,028 | January 1927 | Morser |
| 2,468,721 | April 1949 | Volkmann |
| 3,506,980 | April 1970 | Aileo |
| 3,571,813 | March 1971 | Allen |
| 3,663,973 | May 1972 | Spence |
| 3,938,614 | February 1976 | Ahs |
| 4,071,717 | January 1978 | Fidi |
| 4,170,275 | October 1979 | Larsen |
| 4,278,852 | July 1981 | Gorike |
| 4,389,542 | June 1983 | Gorike |
| 4,523,661 | June 1985 | Scalzo et al. |
| 4,572,324 | February 1986 | Fidi et al. |
| 4,809,811 | March 1989 | Gorike |
| 4,856,118 | August 1989 | Sapiejewski |
| 4,958,697 | September 1990 | Moody |
| 4,989,271 | February 1991 | Sapiejewski et al |
| 5,020,163 | June 1991 | Aileo et al. |
| 5,138,722 | August 1992 | Urella et al. |
| 5,500,958 | March 1996 | Falco |
| 5,911,314 | June 1999 | Urella et al. |
| 5,911,314 | June 1999 | Urella et al. |
| 5,920,911 | July 1999 | Cushman |
| 6,163,615 | December 2000 | Callahan |
| 6,683,965 | January 2004 | Sapiejewski |
| 6,684,976 | February 2004 | Sheppard, Jr. |
| 6,856,690 | February 2005 | Skulley |
| 7,245,736 | July 2007 | Tsunoda et al. |
| 1,652,655 | December 1927 | Alexander |

### BRIEF DESCRIPTION OF THE DRAWINGS

The aspects on the CEP may be more completely understood in consideration of the following detailed descriptions of the included figures.

FIG. 1:

This a 3d rending of a CEP. In it the following elements are seen.
1 The top of the CEP has a ledge for the attachment of a soft material (e.g. rubber, felt, suede) that will be placed against the user's skin. This is the larger diameter end of the CEP. The material itself is not important to this disclosure.
2 There are 3 ridges used in this CEP to help disperse the sound waves. The number and size of the protrusions can vary.
3 This CEP has 6 “port” holes that are used to alleviate excessive pressure build up. The number and size of the ventilation holes can vary.
4 The base of the CEP has a mechanical mounting point to attach to the CEP to the headphone cup or other transmitting device. This is the smaller diameter of the CEP.

FIG. 2:

This is a 3D rendering of the back side of a different CEP. In it the following elements are seen.
1 This CEP has 6 “port” holes that are used to alleviate excessive pressure build up.
2 There is an alignment ring to align the CEP with the headphone cup for which it was designed.
3 There are pockets for magnets to magnetically connect the CEP to the headphone cup for which it was designed.

FIG. 3:

This is an actual CEP. In it the following elements are seen.
1 The top of the CEP has a rubber attachment that will be placed against the user's skin.
2 There are 3 ridges used in this CEP to help disperse the sound waves.
3 This CEP has 6 “port” holes that are used to alleviate excessive pressure build up.
4 There is a port plug to allow the user to determine how much sound wave pressure should be allowed to develop.

FIG. 4:

This figure shows that the CEP utilizes a multi-walled construction methodology with an air gap in between walls.

While the aspects of the disclosure are amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### TECHNICAL FIELD

The disclosure is related to the usage of ear pads for “on the ear” and “over the ear” applications. These ear pads are connected to headphone cups and other external sound transmission devices. This disclosure does not apply to “In Ear Monitors” that are placed inside the listener's ear.

### BACKGROUND

Headphones can be categorized into the following groups:
1 External passive headphones for listening to sound reproduction.
2 External active noise canceling headphones for listening to sound reproduction.
3 Ear muffs or ear protectors used to keep external sounds from reaching the user's ears.
4 In Ear Monitors which includes ear buds and ear phones that are placed inside the user's ear cannel.

In relation to the first 2 groups, an ear pad forms a passage way between the user's ear and the transducer (i.e. speaker) that is producing the sound replication. While there have been some cone shaped pads in the past (patents 1527802, 3030458, 4170275) most pads are donut shaped (patents 4856118, 5020163, 6163615). The donut shaped pad with 90 degree walls became particularly popular with ear muffs (patent 5138722). As a result of the ear muff research, the donut pad is widely used for both on the ear (i.e. the pad rests on the ear) and over the ear headphones (i.e. the ear is located within the pad walls).

The benefits of the donut shaped pad are:
1 Easy to produce.
2 Good at keeping external sounds from reaching the user's ears.

The problems with the donut shaped pads are:
1 Limits the development of the sound wave.
2 Creates sound canceling reflections as the sound waves bounce of the walls at a 90 degree angle and collide into each other.
3 Creates a compressed “headphone sound” versus listening to speakers.

With recent advances in the fidelity of sound reproduction it has become necessary to develop an ear pad that:
1 Increases sound wave development.
2 Minimizes unwanted reflections.
3 Directs the sound wave reflections towards the user's ear cannel.

### SUMMARY

It has long been known, to the audio community, that the horn shape (patent 1652655) allows sound waves to develop. This occurs because the horn shape takes sound from the higher pressure transducer area and expands the waves into the lower pressure horn mouth area. The shape, size, and length of the horn determines it's frequency response.

External passive and active headphone ear pads are much too short to fully act as a horn. But the principal that the cone shape allows the sound to expand still applies. The Conical Ear Pad (for the remainder of the document referred to CEP) applies horn theory and becomes a conduit or a mini listening environment versus functioning only as a cushion for the user's ear.

Once the sound waves have developed, in the new mini listening environment, they must be controlled. Past patents focus on the materials used for control (e.g. 5920911). The CEP incorporates elements that are found in listening environments equipped with speakers. These elements focus on sound wave absorption, dispersion, and pressure build up.

In the detailed description section, the following areas will examined:
1 Shape
2 Construction
3 Features

### BRIEF DESCRIPTION OF THE DRAWINGS

The aspects on the CEP may be more completely understood in consideration of the following detailed descriptions of the included figures.

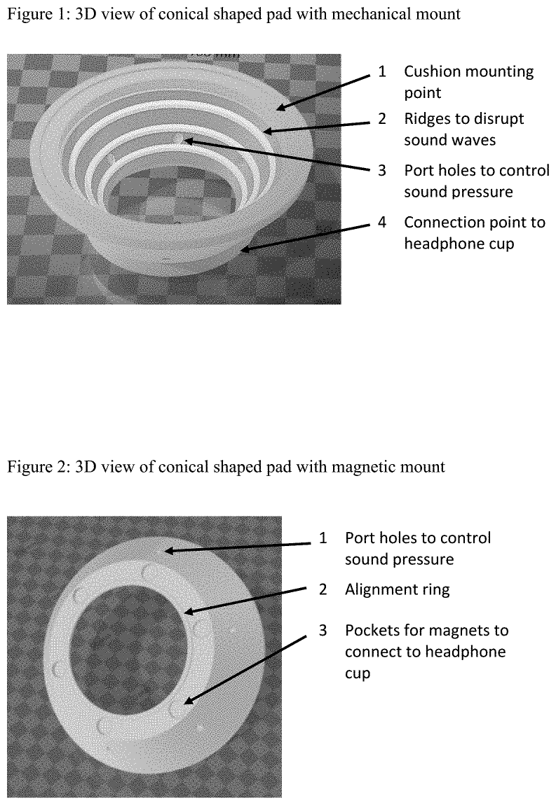

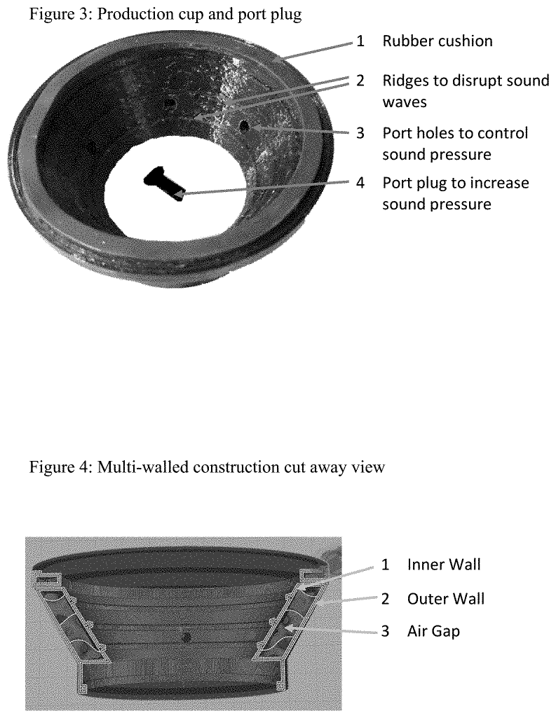

FIG. 1:

This a 3d rending of a CEP. In it the following elements are seen.
1 The top of the CEP has a ledge for the attachment of a soft material (e.g. rubber, felt, suede) that will be placed against the user's skin. This is the larger diameter end of the CEP. The material itself is not important to this disclosure.
2 There are 3 ridges used in this CEP to help disperse the sound waves. The number and size of the protrusions can vary.
3 This CEP has 6 “port” holes that are used to alleviate excessive pressure build up. The number and size of the ventilation holes can vary.
4 The base of the CEP has a mechanical mounting point to attach to the CEP to the headphone cup or other transmitting device. This is the smaller diameter of the CEP.

FIG. 2:

This is a 3D rendering of the back side of a different CEP. In it the following elements are seen.
1 This CEP has 6 “port” holes that are used to alleviate excessive pressure build up.
2 There is an alignment ring to align the CEP with the headphone cup for which it was designed.
3 There are pockets for magnets to magnetically connect the CEP to the headphone cup for which it was designed.

FIG. 3:

This is an actual CEP. In it the following elements are seen.
1 The top of the CEP has a rubber attachment that will be placed against the user's skin.
2 There are 3 ridges used in this CEP to help disperse the sound waves.
3 This CEP has 6 “port” holes that are used to alleviate excessive pressure build up.
4 There is a port plug to allow the user to determine how much sound wave pressure should be allowed to develop.

FIG. 4:

This figure shows that the CEP utilizes a multi-walled construction methodology with an air gap in between walls.

While the aspects of the disclosure are amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary.

### Shape

The CEP derives its name from the slope internal sides. The angle of the internal sides typically ranges from 40 to 70 degrees and is dependent on the following factors:
1 How wide is the mounting service on the transducer side?
2 How much space is available between the transducer and the user's ear or sound receptor?
3 What is the diameter of the hole required for the transducer?
4 What is the diameter of the hole required for the user's ear or sound receptor?

In the included diagrams, all the transducers are circular in nature. Therefore, these CEPs have a smaller circular base (transducer side) and larger diameter circular mouth (receptor side). This is not to imply that only circular openings can be employed. For example, a CEP may employ elliptical openings. The same sloped walls would apply.

Because the CEP's focus is on sound transmission and not sound dampening, the external walls are not required to be as thick as a typical doughnut pad. Therefore, the CEP is not required to have external 90 degree walls. The slope of the exterior wall is instead determined by the minimal amount of material required for:
1 Wall strength.
2 Mating mechanism.
3 Mating surface.
4 Aesthetics.

The reason for the slope shaped can be found in speaker and horn theory. Simply put, when a sound wave develops it expands in a curved boundary. Much like ice cream on a cone. As it expands, the sound wave will reflect off any surface it encounters. If there are parallel surfaces, the reflecting sound waves will reflect back unto themselves. With sloped surfaces the sound waves reflect out towards the mouth of the cone and into the user's ear or sound receptor device.

### Construction

Multi-wall construction is not uncommon in in headphone pads. All the related patents cited use multi-walled construction methodologies. The difference between the CEP and other ear pads are the materials used and is what is placed between the inner and outer walls.

Most common ear pads are filled with foam. Although silicon and viscous liquids can be found in the cited patents (e.g. 4856118).

The CEP has an air gap between the inner and outer walls, FIG. 4. The air gap lessens the weight of the CEP. To retain wall rigidity the CEP utilizes an internal “lattice” type of structure.

The wall material must be light and flexible. Various filaments, resins and polymers make excellent candidates for wall material. Flexibility and rigidity are balanced so that the CEP can retain its form while providing some conformity with the mating surfaces.

As of this writing, the actual construction of the CEP is best performed by 3D printing or molding. This is due to the current state of production technology in relation to the air gap, internal structure, and materials. This does not mean to imply that this is the only technology and materials that can be used. As technology and materials change, the construction of the CEP may also change. The spirit of the construction is:
1 Flexible walls.
2 Gap between the walls.
3 Limited or no filler.
4 Light weight.

### Features

The first feature is a balance of sound reflection and absorption. When sound waves reflect off of surfaces, the type of surface will dictate how that reflection is perceived. For example, hard surfaces can sound harsh in the upper frequency range. Soft surfaces absorb sound causing the sound to be perceived as muted or dull.

Doughnut pad technology is designed to keep sound out and does so through the usage of sound absorbing materials. Therefore, this type of pad places a priority on sound absorption.

A flexible multi-wall air gap construction will have some flexibility to the sound waves. This will absorb some of the sound. But without the sound deadening material, a larger portion of the sound will be reflected than with a traditional ear pad. In order to ensure a proper reflection angle, a level of rigidity is required to ensure that the CEP maintains it's shape.

The second feature is sound dispersion. Surface structure also affects the reflection of the sound waves. In listening rooms diffusers are used to help control the reflections. The ridges inside the CEP, FIG. 1, perform a similar function. The number and height of the ridges affect different frequencies by differing amounts. Changing the ridges changes the tonality of the CEP. Therefore, the CEP can be tuned to the user's tonality preference. This is not possible with current doughnut and foam construction techniques. The ridges used in the example figures do not imply that other internal protruding structure may not be employed with the same result dispersion.

The final feature is the management of sound wave pressure build up. In a listening room, bass and corner traps are employed for this functionality. The size of an ear pad does not lend itself to such devices. Therefore, pressure relief mechanisms are installed to alleviate pressure build up. In FIGS. 1-3 these are referred to as “ports”. This is not meant to imply that a round hole is the only method of venting excess pressure. The amount of perceived bass is inversly proportional to the amount of pressure ventilation. More sound pressure creates a perception of more bass. The CEP is designed with an amount of ventilation that reflects the user's tonality preferences. Excess ventilation is added during the construction and “port plugs”, FIG. 3, are provided to allow the user to fine tune the tonality of the CEP. The ports used in the example figures do not imply that other pressure relieving methods or shapes may not be employed to affect the same result.

The manner by which the CEP mounts to the transceiver is not important. Any manner of mounting arrangements can be employed to attach the transceiver to the CEP.

The softening material mounted to the receptor/ear side of the CEP is not important. Any manner of materials can be attached.

What is claimed is:

1. A Conical Ear Pad (CEP) designed for the transmission of sound from the transducer to the ear or other receiving device.

2. Usage of sloped walls to direct the sound wave reflections towards the ear or other receiving device. The angle of the slope is typically 40 to 70 degrees.

3. Construction that is a flexible, multi-walled, and limited filler design so as to balance sound wave absorption with sound wave reflection.

4. Incorporation of internal protrusions to manage sound wave reflections.

5. Integrated pressure relieving devices to remove unwanted sound pressure build up.
